(19) United States
(12) Patent Application Publication
(10) Pub. No.: US 2005/0044371 A1
(43) Pub. Date: Feb. 24, 2005

(54) Deterring counterfeiting using custom colored inks

(75) Inventors: Gordon W. Braudaway, Yorktown Heights, NY (US); Ravi Prakash, Concord, NC (US)

Correspondence Address: Louis P. Herzberg;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/629,088

(22) Filed: Jul. 29, 2003

(51) Int. Cl. H04L 9/00

(52) U.S. Cl. 713/176

(57) ABSTRACT

The present invention provides methods and apparatus for an effective deterrent to casual counterfeiting. An example method of achieving the deterrent exploits the limited color gamut of commonly available printers by using selected inks having colors that are out-of-gamut colors for those printers. Another example of a method of the present invention provides for achieving the deterrent by sorting a plurality of candidate documents into a first group of scanned documents not having the out-of-gamut color, and into a second group of scanned documents having the out-of-gamut color, so that the scanned documents in the first group being probably counterfeit, and the scanned documents in the second group being possibly authentic.

### FIELD OF THE INVENTION

This application is directed to the fields of digital imaging and counterfeit deterrence. It is more specifically concerned with the printing of identifying marks on a hard copy using custom color inks, and the subsequent detection or non-detection of those identifying marks in a digitized image of the hard copy.

### BACKGROUND OF THE INVENTION

It is a constant endeavor to find improved techniques for placing visible identifying marks onto printed material that are difficult or impossible to reproduce using common desktop scanners and printers, and even by many three and four color industrial printing processes. The marks are placed at specified locations on the hard copy and have visibly significant sizes. The areas covered by the marks are called areas of coverage. The ability to detect the presence of those identifying marks in a scanned and digitized image of the printed material is generally useful in establishing authenticity of the scanned object. More importantly, the detected absence or alteration of the color of the identifying marks is an immediate indication of a possibly counterfeit copy.

With the present easy availability of image scanners and color printers that produce relatively good quality replicas of hard copy documents, the risk of what is called “casual counterfeiting,” that is, counterfeiting done by novices, has greatly increased. It would be advantageous to have an inexpensive and effective deterrent to casual and other counterfeiting.

### SUMMARY OF THE INVENTION

Thus, the present invention provides an effective deterrent to casual counterfeiting. In one aspect, a method of achieving the deterrent exploits the limited color gamut of commonly available printers by using selected inks having colors that are out-of-gamut colors for those printers.

Another aspect of the present invention provides for achieving the deterrent by sorting a plurality of candidate documents into a first group of scanned documents not having the out-of-gamut color, and into a second group of scanned documents having the out-of-gamut color, so that the scanned documents in the first group being probably counterfeit, and the scanned documents in the second group being possibly authentic.

An example of a method implementing the present invention includes the steps of: providing a plurality of authentic hard-copy documents, each of the authentic hard-copy documents including at least one mark having at least one color that is out of gamut of a printing device having at least three colors; color scanning a plurality of candidate documents to form a two-dimensional array of image pixels for each candidate document; searching each array for the at least one color; sorting the plurality of candidate documents into a first group of scanned documents not having the at least one color, and into a second group of scanned documents having the at least one color, so that the scanned documents in the first group being probably counterfeit, and the scanned documents in the second group being possibly authentic.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 shows an a*-b* chrominance plane for L*=70;

FIG. 2 shows an a*-b* chrominance plane for L*=45;

FIG. 3 illustrates a color selection in the differential gamut that can be produced using custom colored inks but can not be produced by any combination of inks available to the example printer;

FIG. 4 shows example spectral distributions of three typical color filters that could be used, one in front of each of the three image sensors, to produce a calorimeter; and

FIG. 5 shows an example embodiment of the present invention.

### DESCRIPTION OF THE INVENTION

The present invention provides methods, systems and apparatus for effective deterrent to casual and other counterfeiting. With the present easy availability of image scanners and color printers that produce relatively good quality replicas of hard copy documents, the risk of what is called “casual counterfeiting,” that is, counterfeiting done by novices, has greatly increased. In an example embodiment of a method of achieving the deterrent is to exploit the limited color gamut of commonly available printers by using selected inks having colors that are out-of-gamut colors for those printers. In this way, even though a scanner may accurately capture the out-of-gamut colors, it will not be possible for the commonly available printer to accurately reproduce the colors. The absence of the correct colors in the counterfeit printed copy can be detected.

As used herein, a digital image is an abstraction of a physical image that has been scanned and stored in a computer's memory as rectangular arrays of numbers corresponding to that image's (one or more) color planes. Each array element corresponds to a very small area of the physical image and is called a picture element, or pixel. The numeric value associated with each pixel for a monochrome image represents the magnitude of its average brightness of its single color (for example, black and white) plane. For a color image, each pixel of the digital image has associated values representing the magnitudes of average brightness of its at least three color components represented in three or more color planes. The color components are associated with spectrally dispersed primary colors used to represent a broad range of colors in the visible color spectrum, and the values of the at least three color components are the relative brightness of the three primaries used to represent a particular color.

If the digital image has been converted from continuous tone picture elements to halftone picture elements, the halftone picture elements will be referred to herein as pels and their color component values referred to as ink-density values. As with pixels, a different value is associated with each different one of the image's color planes for each pel, and the number of color planes in the halftoned representation may be greater than the number of color planes in the digital image. Thus, the digital image and the hard copy printed from the halftoned image are two distinct, but related, representations of the same physical image.

Herein the word halftoned will be taken to mean that gradations from light to dark are obtained by the relative darkness and density of tiny dots of inks that are to be applied to paper or other substrate material. Also, if the digital image is a color image, its pixel values are ordinarily the relative brightness values of additive radiant primary colors, such as those of a computer's display. Therefore, the halftone conversion process as referred to herein also includes conversion of the pixel values of radiant primary colors into the pel values of light absorbing primary colors (such as Cyan, Magenta, Yellow and Black ink densities) that are needed for printing. The halftoned image then may be printed on paper or other substrate material; such printed image is herein called a hard copy.

Whenever reference is made herein to color planes, it is understood to include any number of color planes used by a particular image's digitizing technique to define the pixel's or pel's color characteristics. Pixel values, as well as pel values, have a magnitude represented by at least one binary digit or bit.

Whenever reference is made herein to ink density or ink-density value, it is understood to refer to any substance that is used to apply color to paper or other substrate material, be that substance ink, dye, toner or other. Further, ink-density values range from 0% to 100%, meaning from no ink applied to the area of a picture element on paper up to total coverage of the area on paper.

Specific colors are definable by specific values of their color components. Although it is possible mathematically to define pixel or pel color component values that are greater than 100% or less than 0%, such specific colors are not physically realizable. The three dimensional volumes that contain all possible combinations of picture element color component values are called gamuts. Only those colors lying on the surface of or within the volume of a gamut can be created from the given set of primary colors that define the gamut. The colors that can physically exist but can not be realized by any combination of the primary colors defining a gamut are called physically-realizable out-of-gamut colors. The explicit use of out-of-gamut colors is the essence of the present invention.

To further explain the meaning and utility of out-of-gamut colors, the international standard color representation CIE 1976 (L*a*b*), herein referred to as CIELab, will be used. This color representation standard is described in Wyszecki, G and Stiles, W. S., Color Science: Concepts and Methods, Quantitative Data and Formulae, Second Edition, John Wiley & Sons, NY, 1982, which is herein included by reference.

All colors in the spectrum of physical colors can be represented by a their coordinates in a three dimensional color space. The three dimensions herein will be called a triplet. The CIELab coordinates, namely L*, a* and b*, used herein, are color triplets in a perceptual color space. By this, it is meant that moving an equal distance from a first triplet in any direction to another triplet will be perceived by a human viewer as an approximately equal change in perceived color. Thus, the distances moved from a first triplet by a just noticeable difference in color will be approximately equal, and the locus of all colors of just noticeable color differences will roughly lie on a sphere surrounding the first triplet. The coordinate L* ranges from 0 to 100. The triplet [100,0,0] represents the coordinates of a reference white. For hard copy, the reference white is taken to be the measured values of the substrate with no applied inks under a specified illuminating source. The triplet [0,0,0] represents black, a color of unmeasurably small luminance.

Changes in the perceived luminance of a color will correspond to changes of only the coordinate L*, and changes of chrominance that produce an equally perceived luminance will involve changes of only the coordinates a* and b*. Thus, it is informative to view the a*-b* chrominance planes in which L* is a constant.

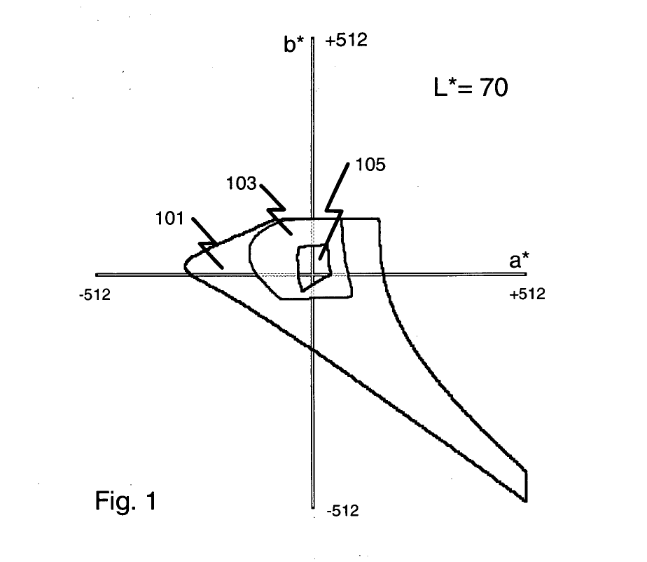

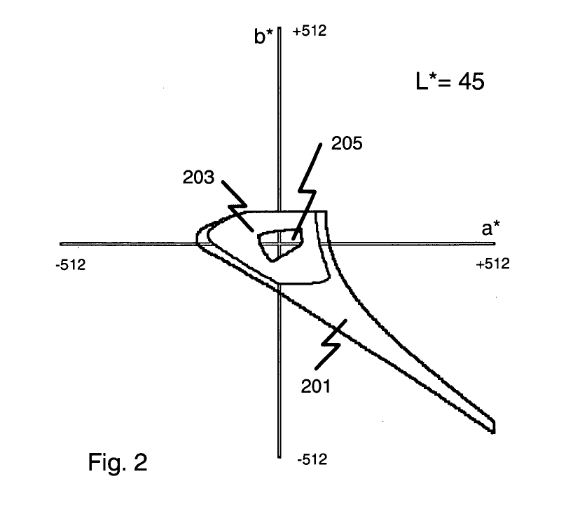

Referring to FIG. 1 and FIG. 2, the chrominance plane is shown for L*=70 and L*=45, respectively. The three nested areas shown represent the gamut of physically-realizable colors (101) and (201), the gamut of object colors (103) and (203) and the gamut of printable colors (105) and (205). Not all combinations of a* and b* represent physically realizable colors. Only those combinations that lie within the areas (101) and (201) are physically realizable. Object colors are colors that arise by the reflection of a reference illumination source from an object, which in our case is paper with applied inks. The gamut of object colors is considerably smaller than that of physically realizable colors. Physically realizable colors do not have to depend on reflected light and can therefore be made up of any number of radiating sources, as opposed to the single reflected reference source for object colors. Still smaller is the gamut of printable colors, which represents all colors (of course, having the same L*) that can be reproduced by any combination of the primary color inks used in the printing process. The area outside the printable colors gamut but inside the object colors gamut is the area of interest for the present invention. Colors lying in this in-between area are those that can be reflected from custom color inks applied to paper.

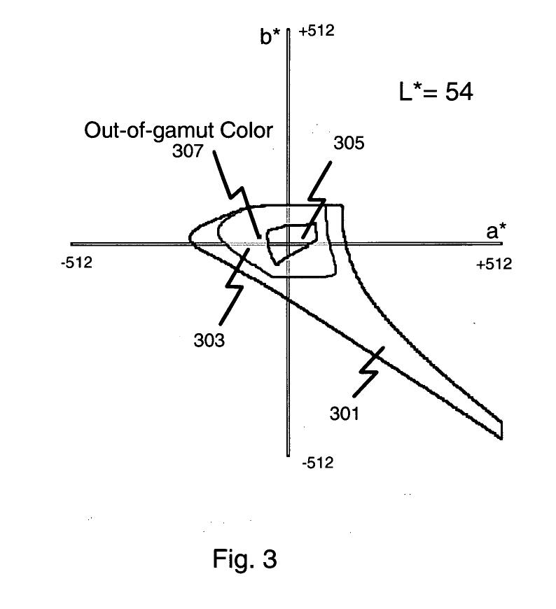

It should be apparent that if the planes of constant L* are stacked one on another in numerical order from L*=0 to L*=100, three dimensional volumes will be produced. The three-dimensional gamut of printable colors lies entirely within or touching the three-dimensional object color gamut which, in turn, lies totally within or touching the three-dimensional gamut of physically realizable colors. As with the differential area of the two-dimensional a*-b* plane, the differential gamut volume lying outside the printable colors gamut volume but inside the object colors gamut volume is the volume of interest for then present invention. FIG. 3 illustrates a color selection, a deep green (307), in the differential gamut that can be produced using custom colored inks but can not be produced by any combination of inks available to the example printer. It lies outside the gamut of printable colors (305) but inside both the gamut of object colors (303) and the gamut of physically-realizable colors (301). The gamuts of most three color or four color printers are very similar in shape and size and those printers can only print approximate representations of the out-of-gamut colors that lie within the differential volume.

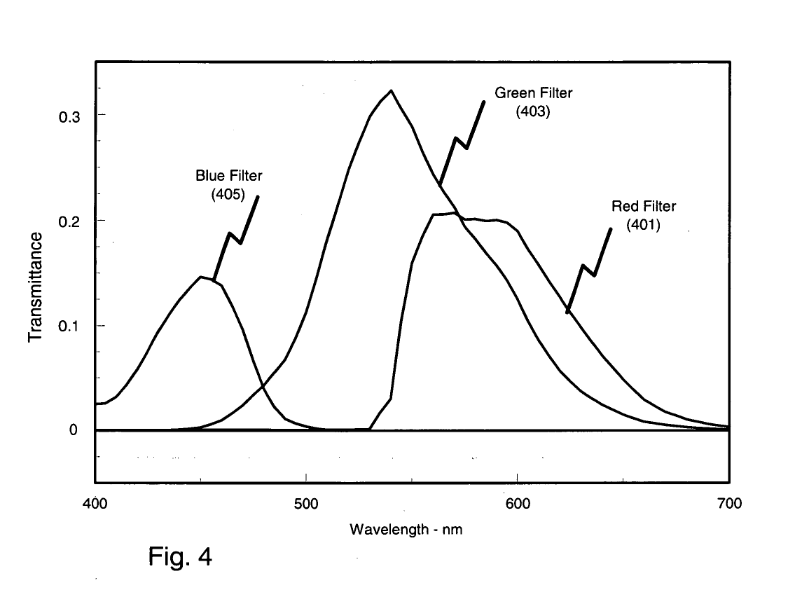

An example embodiment of the present invention is in the apparatus used for scanning and sorting of bank checks and/or other transaction documents, at very high speed. In this embodiment, detection of included out-of-gamut colors on bank checks is done by a rudimental colorimeter. A typical rudimental calorimeter is embodied by using three image scanning elements that are optically focused on the illuminated stream of paper checks. Each scanning element is covered by a different colored spectral filter. FIG. 4 shows example spectral distributions of three typical color filters, a red appearing filter (401), a green appearing filter (403), and a blue appearing filter (405), that could be used, one in front of each of the three image sensors. Establishing and calibrating ratios of the scanned values of the three scanning elements, when focused on an identical area of the bank check, allows the average color of that area to be measured.

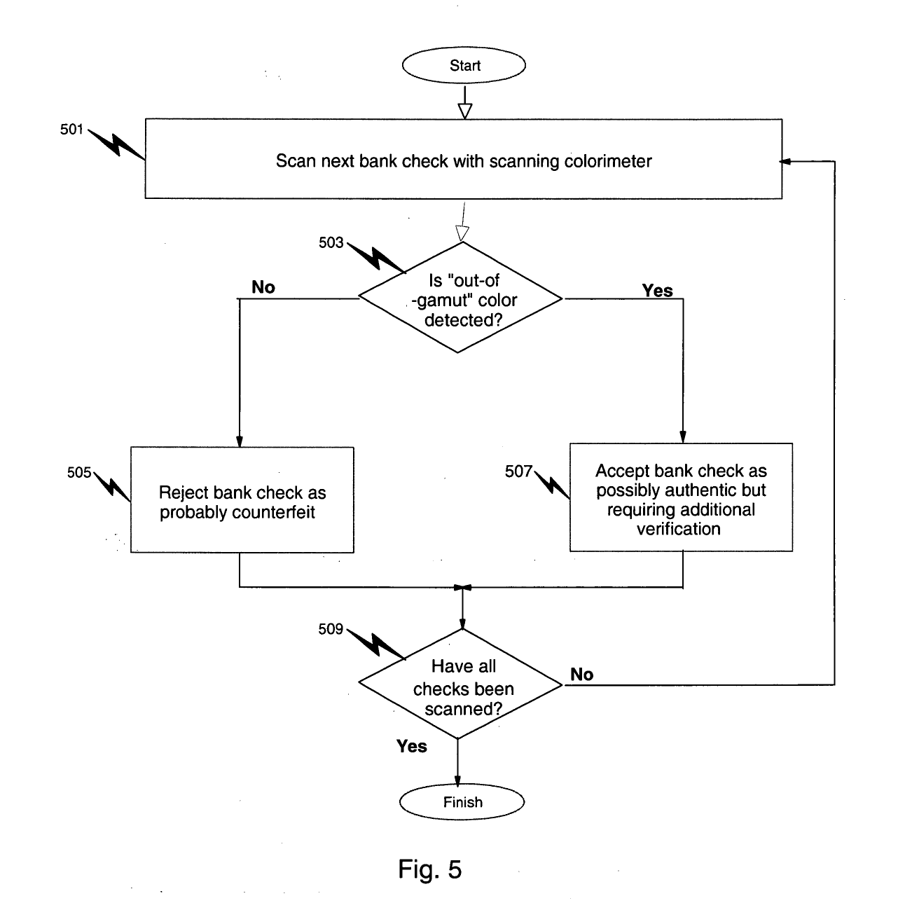

In an example embodiment, referring to FIG. 5, the illuminated bank check stream is scanned by the colorimeter (501). If the presence of the correct out-of-gamut color is not confirmed by scanned color values from the image scan (503), the document is rejected as a possible counterfeit (505). Conversely, if the specific out-of-gamut color is detected, within a specified color tolerance, the document can be classified as probably authentic (507), pending other checks of authenticity that are not dependent on color discrimination, such as the shape or placement of the out-of-gamut colored object in the document image. If all bank checks have been scanned (509), the process is finished; otherwise steps (501) through (509) are repeated.

It will be clear to those skilled in the art that other modifications to the disclosed embodiments can be effected without departing from the spirit and scope of the invention. For example, a calorimeter can be embodied using a single scanning element with a segmented three-color filter placed near its object focal plane. The described embodiments ought to be construed to be merely illustrative of some of the more prominent features and applications of the invention. Other beneficial results can be realized by applying the disclosed invention in a different manner or modifying the invention in ways known to those familiar with the art.

Thus the present invention includes a method includes the steps of: providing at least one hard-copy document, each authentic hard-copy document including at least one mark having at least one color that is out of gamut of a printing device having at least three colors; color scanning a plurality of candidate documents in forming a two-dimensional array of image pixels for each candidate document; searching each array for the at least one color; and sorting the plurality of candidate documents into a first group of scanned documents not having the at least one color, and into a second group of scanned documents having the at least one color, so that the scanned documents in the first group being probably counterfeit, and the scanned documents in the second group being possibly authentic.

In some embodiments of the method each of the pixels has at least three color pixel values; and/or the step of color scanning includes employing a calorimeter; and/or the step of providing includes printing using a custom-color ink; and/or the step of providing authentic hard-copy documents includes providing a plurality of bank checks; and/or further comprises the steps of noting correct pixel locations of the at least one color in the authentic document; determining particular pixel locations of the color in each of the second group of scanned documents, and forming a third group of scanned documents not having the particular pixel locations corresponding to the correct pixel locations, and into a fourth group of scanned documents having the particular pixel locations corresponding to the correct pixel locations, so that the scanned documents in the third group being probably counterfeit, and the scanned documents in the fourth group being possibly authentic.

In further embodiments of a method of the present invention, the method comprises the steps of employing an authentication test taken from a group of authentication tests including: size correspondence; location correspondence; magnetic number correspondence; checking account pattern-of-use exception; unexpected presence of ultraviolet fluorescing; unexpected presence of thermochromic responding; unexpected presence of laser resonating inks; unexpected absence of ultraviolet fluorescing; unexpected absence of thermochromic responding; unexpected absence of laser resonating inks; and any combination of these or other authentication tests.

For example, checking account pattern-of-use exception tests, include, but are not limited to: unexpectedly large gap in check sequence numbers; duplicate check sequence numbers; check sequence number electronically unreadable; new payee inconsistent with previous check writing pattern; unusually large amount of check; unusual deposit of check into a foreign bank account; and any combination of these or other fraud detection tests.

The present invention also includes a method for imparting a plurality of marks onto a hard copy using at least one custom colored ink, and subsequent evaluation of a scanned and digitized image of the hard copy for the purpose of counterfeit detection, including the steps of: providing a hard copy; imparting onto the hard copy at least one visible mark using at least one chosen colored ink, each the marks covering an area of coverage on the hard copy and each area of coverage having defined position within the hard copy; scanning the hard copy to form a digitized image having at least three image planes, each the image plane being represented by an array having pixel brightness data for a plurality of pixels, each of the pixels having at least three color component and having a pixel position; examining the pixels of the digitized image corresponding to the at least one the area of coverage; and determining the presence or absence of the expected color in the at least one area of coverage based on the values of the color components of pixels corresponding to and lying within the area of coverage. In some cases, the scanned and digitized image is a business transaction document.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention.

Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method comprising:
providing at least one authentic hard-copy document, each of said authentic hard-copy document including at least one mark having at least one color that is out of gamut of a printing device having at least three ink colors;
color scanning a plurality of candidate documents to form scanned documents each having a two-dimensional array of image pixels for each candidate document;
searching each array for said at least one color; and
sorting said plurality of candidate documents into a first group of scanned documents not having said at least one color, and into a second group of scanned documents having said at least one color, so that said scanned documents in said first group being probably counterfeit, and said scanned documents in said second group being possibly authentic.

2. A method as recited claim 1, wherein each of said pixels has at least three color pixel values.

3. A method as recited claim 1, wherein the step of color scanning includes employing a calorimeter.

4. A method as recited claim 1, wherein the step of providing includes printing using a custom-color ink.

5. A method as recited claim 1, wherein the step of providing authentic hard-copy documents includes providing a plurality of bank checks.

6. A method as recited claim 1, further comprising:
noting correct pixel locations of said at least one color in said authentic document;
determining particular pixel locations of said at least one color in each of said second group of scanned documents; and
forming a third group of scanned documents not having said particular pixel locations corresponding to said correct pixel locations, and into a fourth group of scanned documents having said particular pixel locations corresponding to said correct pixel locations, so that said scanned documents in said third group being probably counterfeit, and said scanned documents in said fourth group being possibly authentic.

7. A method as recited claim 1, further comprising employing an authentication test taken from a group of authentication tests consisting of:
gamut color size correspondence;
gamut color location correspondence;
magnetic number correspondence;
checking account pattern-of-use exception;
unexpected presence of ultraviolet fluorescing;
unexpected presence of thermochromic responding;
unexpected presence of laser resonating inks;
unexpected absence of ultraviolet fluorescing;
unexpected absence of thermochromic responding;
unexpected absence of laser resonating inks; and
any combination of these authentication tests.

8. An apparatus comprising:
means for providing at least one authentic hard-copy document, each said authentic hard-copy document including at least one mark having at least one color that is out of gamut of a printing device having at least three ink colors;
means for color scanning a plurality of candidate documents in forming a two-dimensional array of image pixels for each candidate document;
means for searching each array for said at least one color; and
means for sorting said plurality of candidate documents into a first group of scanned documents not having said at least one color, and into a second group of scanned documents having said at least one color, so that said scanned documents in said first group being probably counterfeit, said scanned documents in said second group being possibly authentic.

9. An apparatus as recited claim 8, wherein the means for providing authentic hard-copy documents includes means for providing a plurality of bank checks.

10. An apparatus as recited claim 8, further comprising:
means for noting correct pixel locations of said at least one color in said authentic document;
means for determining particular pixel locations of said color in each of said second group of scanned documents; and
means for forming a third group of scanned documents not having said particular pixel locations corresponding to said correct pixel locations, and into a fourth group of scanned documents having said particular pixel locations corresponding to said correct pixel locations, so that said scanned documents in said third group being probably counterfeit, said scanned documents in said fourth group being possibly authentic.

11. A method comprising imparting a plurality of marks onto a hard copy using at least one custom colored ink, and subsequent evaluation of a scanned and digitized image of said hard copy for the purpose of counterfeit detection, including the steps of:
providing a hard copy;
imparting onto said hard copy at least one visible mark using at least one chosen colored ink, each said marks covering an area of coverage on said hard copy and each area of coverage having defined position within said hard copy;
scanning said hard copy to form a digitized image having at least three image planes, each said image plane being represented by an array having pixel brightness data for a plurality of pixels, each of said pixels having at least three color component and having a pixel position;
examining the pixels of said digitized image corresponding to the at least one said area of coverage; and
determining the presence or absence of the expected color in said at least one area of coverage based on the values of the color components of pixels corresponding to and lying within said area of coverage.

12. A method as recited in claim 11, wherein said scanned and digitized image is transaction document.

13. An article of manufacture comprising a computer usable medium having computer readable program code means embodied therein for causing authentication testing, the computer readable program code means in said article of manufacture comprising computer readable program code means for causing a computer to effect the steps of claim 1.

14. A program storage device readable by machine, tangibly embodying a program of instructions executable by the machine to perform method steps for authentication testing, said method steps comprising the steps of claim 1.

15. An article of manufacture comprising a computer usable medium having computer readable program code means embodied therein for causing authentication testing, the computer readable program code means in said article of manufacture comprising computer readable program code means for causing a computer to effect the steps of claim 11.

16. A program storage device readable by machine, tangibly embodying a program of instructions executable by the machine to perform method steps for authentication testing, said method steps comprising the steps of claim 11.

17. A computer program product comprising a computer usable medium having computer readable program code means embodied therein for causing authentication testing, the computer readable program code means in said computer program product comprising computer readable program code means for causing a computer to effect the functions of claim 10.

18. An apparatus for authentication testing including means to effect the functions of claim 11.
